(19) United States
(12) Patent Application Publication
(10) Pub. No.: US 2004/0007561 A1
(43) Pub. Date: Jan. 15, 2004

(54) Method for plasma etching of high-K dielectric materials

(75) Inventors: Padmapani Nallan, San Jose, CA (US); Guangxiang Jin, San Jose, CA (US); Ajay Kumar, Sunnyvale, CA (US)

Correspondence Address: Patent Counsel, Applied Materials, Inc., P.O. Box 450A, Santa Clara, CA, 95052, US

(73) Assignee: Applied Materials, Inc.

(21) Appl. No.: 10/194,566

(22) Filed: Jul. 12, 2002

(51) Int. Cl. C23F 1/00; B44C 1/22; C03C 15/00; C03C 25/68

(52) U.S. Cl. 216/67

(57) ABSTRACT

A method for etching a high K dielectric material comprises etching in a first plasma comprising a halogen containing gas (e.g., chlorine) and a reducing gas (e.g., carbon monoxide) and removing post-etch residue in a second plasma comprising a residue cleaning gas (e.g., oxygen or a mixture of oxygen and nitrogen).

### BACKGROUND OF THE INVENTION

1. Field of the Invention

The present invention relates generally to a method for plasma etching semiconductor substrates. More specifically, the invention relates to a method for etching high K dielectric materials using a gas mixture comprising a halogen gas, a reducing gas, and a residue cleaning gas.

2. Description of the Related Art

The evolution of integrated circuit designs continually requires faster circuitry, greater circuit densities and necessitates a reduction in the dimensions of the integrated circuit components and use of materials that improve electrical performance of such components. Dynamic random access memory (DRAM) integrated circuits are commonly used for storing data in a digital computer. In DRAM, each memory cell comprises a transistor coupled to a sub-micron sized capacitor. The trench, crown, and other types of DRAM capacitors are known in the art. Data (e.g., digital information) is stored in each memory cell as a charge on the capacitor. To facilitate construction of larger DRAM, smaller memory cells are needed. One limitation to reducing the size of memory cells is that the capacitors must have sufficient capacitance for reliable charge storage.

The capacitance of a DRAM capacitor may be increased by using a dielectric material with a high dielectric constant. Generally, in the DRAM capacitor a doped silicon substrate acts as a first electrode of the capacitor, a doped polysilicon layer acts as a second electrode of the capacitor, and the dielectric material with a high dielectric constant acts as an insulator between the electrodes. A metal layer is generally formed atop the doped polysilicon layer to provide an electrical connection for the polysilicon to the lines of DRAM. The insulator in the prior art capacitors is typically formed from a composite stack of a layer or layers of materials having a high dielectric constant such as HfO₂, Al₂O₃, ZrO₂, barium strontium titanate (BST), lead zirconate titanate (PZT), ZrSiO₂, HfSiO₂, HfSiON, TaO₂, and the like.

Fabrication of a capacitive structure comprises a process of plasma etching the insulator layer formed from a dielectric material with a high dielectric constant. Generally, during the etching process, a silicon layer or a polysilicon layer of the capacitive structure rather than a conventional carbon-based photoresist mask is used as an etch mask to protect a defined portion of the dielectric material from exposure to an etchant plasma. The chemistry used for etching the dielectric material with a high dielectric constant comprises a chlorine containing gas and carbon monoxide. A detailed examination of the etched layer discovers that a thin film of a carbon-based residue forms on a wafer after plasma etching the dielectric material with a high dielectric constant (e.g., HfO₂). The residue apparently forms during the etching of the dielectric material from either an etchant gas or sub-products of the etching process. After the etch process, the post-etch residue rests on the capacitive structure. Such post-etch residue contaminates the capacitive structure and, unless completely removed, may cause difficulties in depositing further layers that form the capacitive structure or may make the capacitors operate sub-optimally or not at all.

Therefore, there is a need in the art for a method of etching a dielectric material with a high dielectric constant that does not leave a post-etch residue on the wafer.

### SUMMARY OF THE INVENTION

The present invention is a method of plasma etching a dielectric material with a high dielectric constant such as HfO₂, ZrO₂, Al₂O₃, BST, PZT, ZrSiO₂, HfSiO₂, HfSiON, TaO₂, and the like using a gas mixture comprising a halogen gas, a reducing gas, and a residue cleaning gas. The method provides a residue free etching of the dielectric material and comprises a plasma etch process having an etch step and a post-etch residue removal step. In one embodiment of the invention, the residue cleaning gas comprises oxygen (O₂). In another embodiment, the residue cleaning gas comprises a mixture of oxygen and nitrogen (N₂).

### BRIEF DESCRIPTION OF THE DRAWINGS

The teachings of the present invention can be readily understood by considering the following detailed description in conjunction with the accompanying drawings, in which:

FIG. 1 depicts a schematic diagram of a plasma processing apparatus of the kind used in performing the etching processes according to one embodiment of the present invention;

FIG. 2 depicts a flow diagram of an exemplary embodiment of the present invention;

FIG. 3 depicts a schematic cross-sectional view of a substrate having a film stack in accordance with an example of the present invention;

FIG. 4 is depicts a schematic cross-sectional view of a film stack of FIG. 3 after performing an etch step in accordance with an example of the present invention;

FIG. 5 depicts a schematic cross-sectional view of a film stack of FIG. 4 after performing a residue removal step in accordance with an example of the present invention; and

FIG. 6 is a table of process parameters in accordance with one embodiment of the present invention.

To facilitate understanding, identical reference numerals have been used, where possible, to designate identical element that are common to the figures.

It is to be noted, however, that the appended drawings illustrate only typical embodiments of this invention and are therefore not to be considered limiting of its scope, for the invention may admit to other equally effective embodiments.

### DETAILED DESCRIPTION

The invention comprises a method of etching a dielectric material with a high dielectric constant such as HfO₂, ZrO₂, Al₂O₃, barium strontium titanate (BST), lead zirconate titanate (PZT), ZrSiO₂, HfSiO₂, HfSiON, TaO₂, and the like using a gas mixture comprising a halogen containing gas, a reducing gas, and a residue cleaning gas. Herein the materials having a high dielectric constant are referred to as high K dielectric materials. The high K dielectric materials have a dielectric constant greater than 4. The exact stoichiometry of a high K dielectric material is not critical and may vary from the ratio given in the formulas.

The inventive method comprises a plasma etch process having an etch step and a residue removal step. The etch step and residue removal step may be performed in the same plasma etch reactor (herein referred to as performed in-situ). During the etch step, the method uses an etching chemistry comprising a gas (or gas mixture) containing a halogen containing gas (chlorine (Cl₂), hydrogen chloride (HCl), and the like) and a reducing gas (carbon monoxide (CO) and the like). During the residue removal step, the method uses a residue cleaning gas comprising oxygen (O₂). The type of halogen gas and reducing gas are selected to best remove a metal and oxygen from a layer of the high K material, respectively. The type of the residue cleaning gas is selected to best remove the residue (herein also referred to as post-etch residue) that is present on the substrate (herein also referred to as wafer) after the etch step.

The present invention can be reduced to practice in a Decoupled Plasma Source (DPS), DPS-II, DPS plus, or DPS DT etch reactor of a Centura® semiconductor wafer processing system that is available from Applied Materials, Inc. of Santa Clara, Calif. The DPS reactor uses a 2 MHz inductive plasma source to generate and sustain a high density plasma and a 13.56 MHz source to bias a wafer. The decoupled nature of the plasma and bias sources allows independent control of ion energy and ion density. The DPS reactor provides a wide process window over changes in source and bias power, pressure, and etchant gas chemistries and uses an endpoint system to determine an end of the processing.

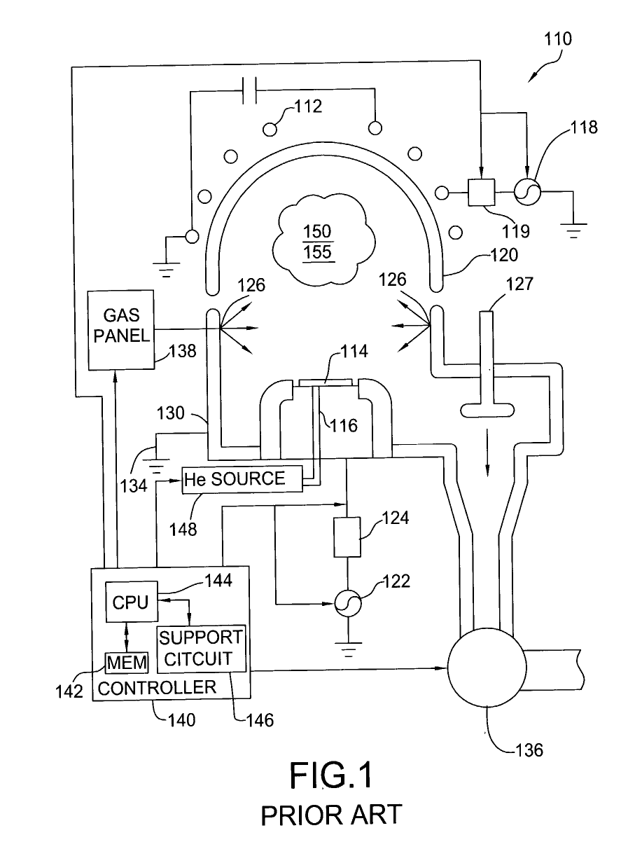

FIG. 1 depicts a schematic diagram of the DPS etch reactor 100 that may be uses to practice the inventive method. The process chamber 110 comprises at least one inductive coil antenna segment 112, positioned exterior to a dielectric, dome-shaped ceiling 120 (referred to herein as the dome 120). Other modifications may have other types of ceilings, e.g., a flat ceiling. The antenna segment 112 is coupled to a radio-frequency (RF) source 118 (that is generally capable of producing an RF signal having a tunable frequency of about 50 kHz and 13.56 MHz. The RF source 118 is coupled to the antenna 112 through a matching network 119. Process chamber 110 also includes a wafer support pedestal (cathode) 116 that is coupled to a source 122 that is generally capable of producing an RF signal having a frequency of approximately 13.56 MHz. The source 122 is coupled to the cathode 116 through a matching network 124. Optionally, the source 122 may be a DC or pulsed DC source. The chamber 110 also contains a conductive chamber wall 130 that is connected to an electrical ground 134. A controller 140 comprising a central processing unit (CPU) 144, a memory 142, and support circuits 146 for the CPU 144 is coupled to the various components of the DPS etch process chamber 110 to facilitate control of the etch process.

In operation, the semiconductor 114 is placed on the wafer support pedestal 116 and gaseous components are supplied from a gas panel 138 to the process chamber 110 through entry ports 126 to form a gaseous mixture 150. The gaseous mixture 150 is ignited into a plasma 155 in the process chamber 110 by applying RF power from the RF sources 118 and 122 respectively to the antenna 112 and the cathode 116. The pressure within the interior of the etch chamber 110 is controlled using a throttle valve 127 situated between the chamber 110 and a vacuum pump 136. The temperature at the surface of the chamber walls 130 is controlled using liquid-containing conduits (not shown) that are located in the walls 130 of the chamber 110.

The temperature of the wafer 114 is controlled by stabilizing the temperature of the support pedestal 116 and flowing helium gas from source 148 to channels formed by the back of the wafer 114 and grooves (not shown) on the pedestal surface. The helium gas is used to facilitate heat transfer between the pedestal 116 and the wafer 114. During the processing, the wafer 114 is heated by a resistive heater within the pedestal to a steady state temperature and the helium facilitates uniform heating of the wafer 114. Using thermal control of both the dome 120 and the pedestal 116, the wafer 114 is maintained at a temperature of between 100 and 500 degrees Celsius. The RF power applied to the inductive coil antenna 112 has a frequency between 50 kHz and 13.56 MHz and has a power of 200 to 2500 Watts. The bias power applied to the pedestal 116 may be in a form of DC, pulsed DC, or RF and is between 0 and 300 Watts.

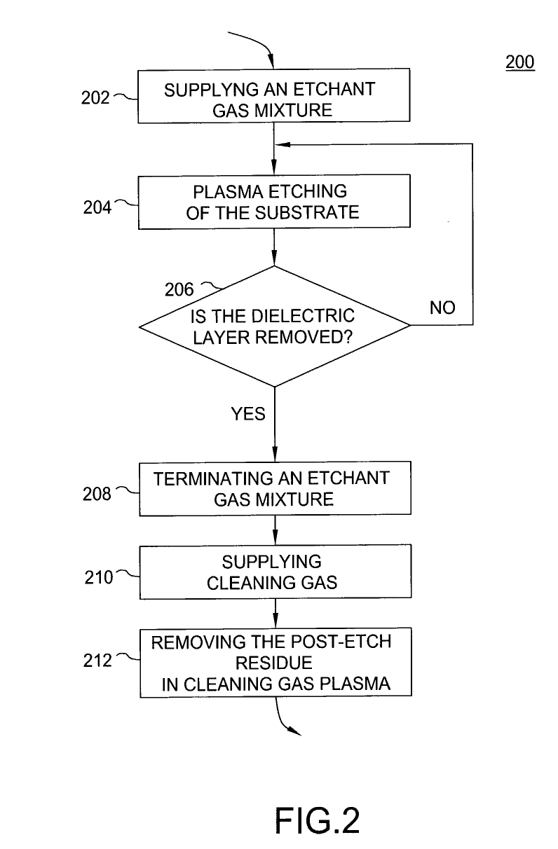

To facilitate control of the chamber as described above, the CPU 144 may be one of any form of general purpose computer processor that can be used in an industrial setting for controlling various chambers and sub-processors. The memory 142 is coupled to the CPU 144. The memory 142, or computer-readable medium, may be one or more of readily available memory such as random access memory (RAM), read only memory (ROM), floppy disk, hard disk, or any other form of digital storage, local or remote. The support circuits 146 are coupled to the CPU 144 for supporting the processor in a conventional manner. These circuits include cache, power supplies, clock circuits, input/output circuitry and subsystems, and the like. The inventive method 200 (described with respect to FIG. 2) is generally stored in the memory 142 as software routine. The software routine may also be stored and/or executed by a second CPU (not shown) that is remotely located from the hardware being controlled by the CPU 144.

Those skilled in the art will understand that other forms of etch chambers may be used to practice the invention, including chambers with remote plasma sources, microwave plasma chambers, reactive ion etch (RIE) chambers, electron cyclotron resonance (ECR) plasma chambers, and the like.

FIG. 2 is a flow diagram of an example of an inventive method 200 wherein a layer of the high K dielectric material is etched for use as an insulator in a capacitive structure, an insulator in a gate structure, or some other structure where a high K dielectric is useful. When etching a dielectric material such as hafnium dioxide, the etchant gas comprises a halogen gas such as chlorine containing gas (e.g., Cl₂) and a reducing gas such as CO, a cleaning gas comprises O₂ or a gas mixture of O₂ and N₂. The method 200 begins, at step 202, by supplying to a reaction chamber an etchant gas (or gas mixture) at a flow rate of 20-300 sccm Cl₂ and 2-200 sccm CO (i.e., a ratio of (0.1-1) (1-0.1). At etching step 204, the etchant gas mixture is energized to form a plasma by applying power to an inductively coupled antenna between 200 to 3000 Watts, applying a cathode electrode bias power between 0 to 300 Watts, and maintaining a wafer temperature between 100 to 500 degrees Celsius and a pressure in the reactor between 2 to 100 mTorr. The etchant gas plasma etches the dielectric material tat is unprotected by an etch mask. The etching step 204 may have a duration that continues until the unmasked portion of the hafnium dioxide layer is completely removed. At step 206, the method queries whether the HfO₂ layer is completely removed during step 204. In a computerized etch reactor (for example, in the DPS etch reactor), at step 206, the decision making routine may be automated using an end-point detection technique. If the query is affirmatively answered, the process proceeds to step 208. If the query is negatively answered, the process proceeds to step 204 for continue etching. The etching step 204 may comprise a main etch process and an overetch process, wherein the process parameters may change during each of the main and overetch processes to optimize the etching results.

Once the high K dielectric material is completely removed, the method 200 proceeds to step 208. At step 208, the etchant gas (or gas mixture) is terminated. At step 210, the cleaning gas is supplied to the reaction chamber at a flow rate of 20-100 sccm O₂ and 0-20 sccm N₂. As such, a chamber may contain all O₂ or a ratio of O₂ to N₂ up to 5:1.

During post-etch residue removal step 212, the cleaning gas is energized to form a cleaning gas plasma by applying power to an inductively coupled antenna between 200 to 2500 Watts, applying a cathode electrode bias power between 0 to 10 Watts, and maintaining a wafer temperature between 0 to 500 degrees Celsius and a pressure in the reactor between 2 to 100 mtorr. When mixed with oxygen, nitrogen improves the control of the activation energy of oxygen. More specifically, nitrogen lowers the activation energy of oxygen, increases dissociation of oxygen in the plasma, and, therefore, increases effectiveness of residue removal step 212.

In one alternative embodiment (not shown), during the etching, the high K dielectric material may be deliberately removed only partially, for example, to make the layer of the high K dielectric material thinner than prior to the etching step. In this embodiment, the etching step continues until a thickness of the layer of the high K dielectric material is reduced to a defined value. Similarly to the method 200, after the etching step, the inventive method proceeds in-situ to the residue removal step. The residue removal step removes the post-etch residue from the surface of the wafer, including the surface of the layer of the high K dielectric material that deliberately has been removed only partially.

During step 212, the cleaning gas plasma removes the post-etch residue from the surface of the wafer. Specifically, the cleaning gas plasma completely removes the post-etch residue from the exposed layers of polysilicon, high K dielectric material, silicon, and silicon dioxide of a capacitive structure. The cleaning gas plasma removes the post-etch residue from the surface of the exposed layers on the wafer by transforming the residue into volatile compositions such as a gas or gases. These volatile compositions are subsequently evacuated from the etch reactor. After step 212, the layers of the capacitive structure are free from the post-etch residue.

In one alternative embodiment, nitrogen may be supplied to the reaction chamber during only a part of step 210. In another alternative embodiment, Cl₂ and CO may be not terminated in step 208 and gradually replaced with O₂ and N₂ during step 210. In such embodiment, the Cl₂/CO plasma gradually transforms into the O₂/N₂ plasma.

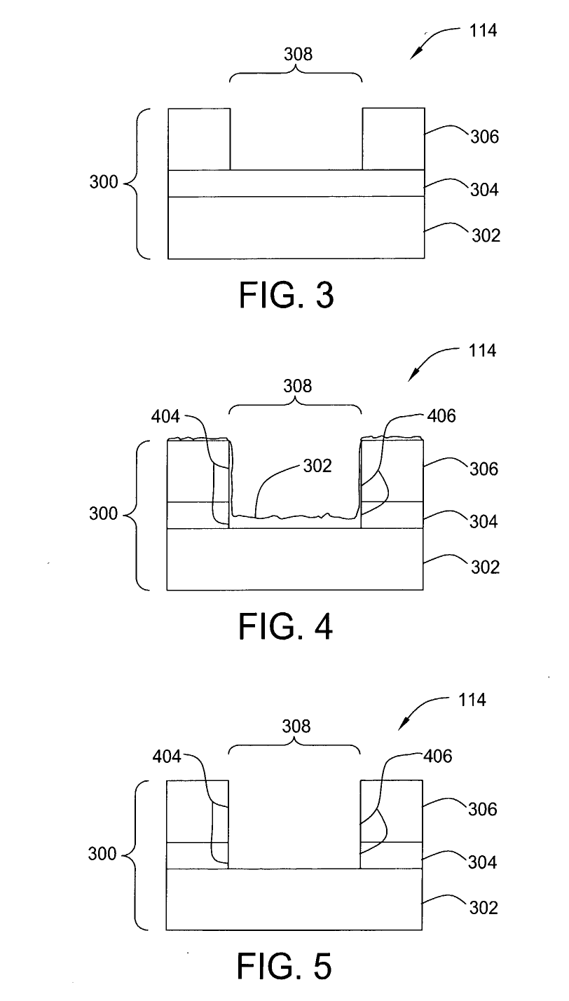

FIG. 3 is a schematic cross-sectional view of the wafer 114 having a film stack 300 in accordance with an example of the present invention. In FIG. 3, the film stack 300 is depicted before etching step 204 (described with respect to FIG. 2). The film stack 300 comprises a silicon layer (or substrate) 302, a high K dielectric layer 304 (for example, a hafnium dioxide layer), and a mask layer 306. The layer 304 has an exposed portion 308 that is unprotected from the etchant plasma by the mask layer 306. Either silicon or polysilicon may be used as the etch mask in the film stack 300 during etching the hafnium dioxide. Alternatively, in a further embodiment, the mask layer 306 may be formed from silicon dioxide (SiO₂). Hafnium-dioxide is a material having a selectivity to silicon and polysilicon of about 3:1 and to silicon dioxide of about 60:1 during etching in a plasma that uses Cl₂ and CO as the etchants.

FIG. 4 is a schematic cross-sectional view of the film stack 300 of FIG. 3 after etching step 204 (described with respect to FIG. 2) in accordance with an example of the present invention. Step 204 etches and removes the unmasked portion 308 of the hafnium dioxide layer 304. In an illustrative example of etching a hafnium dioxide dielectric layer in the DPS etch reactor, one specific process recipe uses 40 sccm of Cl₂, 40 sccm of CO, a chamber pressure of 4 mtorr, an antenna power of 1100 Watts, a pedestal bias power of 20 Watts, and a pedestal temperature of 350 degrees Celsius.

After step 204, a carbon-based post-etch residue 402 may be found on the surface of the wafer. Specifically, the post-etch residue 402 rests on the silicon layer (or substrate) 302, the polysilicon (silicon or silicon dioxide) layer 306, and the side walls 404 and 406 of the film stack 300. The post-etch residue 402 contaminates the film stack 300 and should be removed before further manufacturing processes may be performed (e.g., depositing the glue, barrier, or metal layers of a capacitive structure).

The result of the inventive method can be appreciated by referring to FIG. 5 that depicts a schematic cross-sectional view of a film stack 300 of FIG. 3 after the residue removal step 212 (described with respect to FIG. 2) in accordance with an example of the present invention. Step 212 removes the post-etch residue 402 from the film stack 300 and the wafer 114 using an energized to a plasma cleaning gas comprising O₂ or a mixture O₂ and N₂. In one embodiment, a duration of removing the post-etch residue 402 is between 3 and 30 second. After the post-etch residue 402 has been removed, the wafer 114 may me exposed to further manufacturing processes used during fabrication of a device such as a transistor or memory cell. In an illustrative example of removal the post-etch residue after etching a hafnium dioxide dielectric layer in the DPS etch reactor, one specific process recipe uses 100 sccm of O₂, 20 sccm of N₂, a chamber pressure of 15 mtorr, an antenna power of 1000 Watts, a pedestal bias power of 0 Watts, and a pedestal temperature of 350 degrees Celsius.

In one alternative embodiment (not shown), wherein the high K dielectric material has been deliberately removed only partially during the etching step, the post-etch residue would rest on the surface of the remaining high K dielectric material as well as on the surfaces and side-walls of other layers of a film stack. Similarly to the described above in reference to FIG.5, in such embodiment of the inventive method, a residue removal step in-situ removes the post-etch residue. The residue removal step continues until the post-etch residue is completely removed from the surface of the wafer, including the surface of the layer of the high K dielectric material that has been deliberately removed only partially.

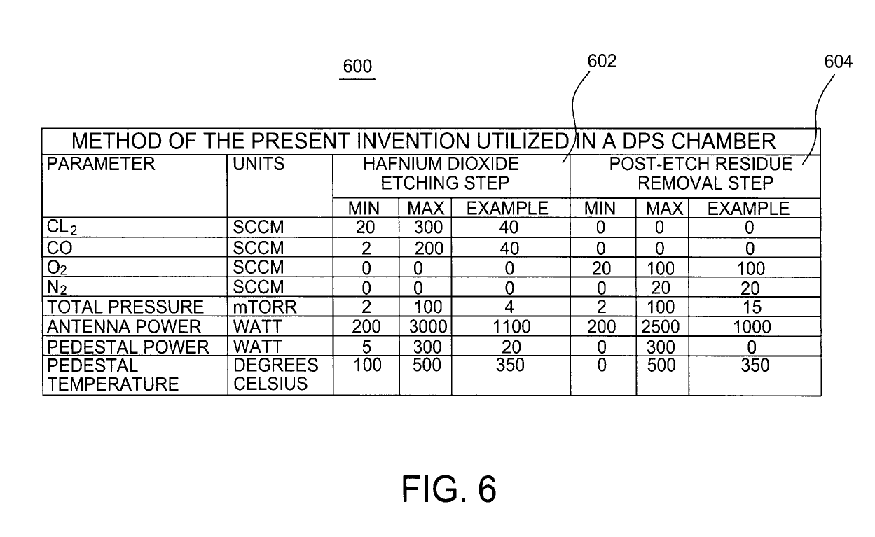

FIG. 6 presents a table 600 summarizing the process parameters through which one can practice the invention using a DPS etch reactor of the Centura® system. The parameters for embodiments of the invention presented above are summarized in columns 602 and 604, respectively. The invention may be practiced using other etching equipment wherein the processing parameters may be adjusted to achieve acceptable characteristics by those skilled in the arts by utilizing the teachings disclosed herein without departing from the spirit of the invention.

While foregoing is directed to the preferred embodiment of the present invention, other and further embodiments of the invention may be devised without departing from the basic scope thereof, and the scope thereof is determined by the claims that follow.

What is claimed is:

1. A method for etching in an etch reactor a substrate comprising a dielectric material having a dielectric constant that is greater than 4, comprising:
etching the dielectric material in a first plasma comprising a halogen containing gas and a reducing gas where said etching step produces a residue; and
cleaning the substrate using a second plasma comprising a residue cleaning gas to remove the residue from the substrate.

2. The method of claim 1 wherein said dielectric material is at least one of HfO₂, ZrO₂, Al₂O₃, BST, PZT, ZrSiO₂, HfSiO₂, HfSiON, and TaO₂.

3. The method of claim 1 wherein said dielectric material is HfO₂.

4. The method of claim 1 wherein the etching step and the cleaning step are performed sequentially in the same etch reactor.

5. The method of claim 1 wherein the halogen containing gas comprises a chlorine containing gas, the reducing gas comprises a carbon monoxide containing gas, and the residue cleaning gas comprises oxygen.

6. The method of claim 5 wherein the chlorine containing gas is Cl₂, the reducing gas is CO, and the residue cleaning gas is O₂ or a mixture of O₂ with N₂ or a mixture of O₂ with N₂ and an inert gas such as He.

7. The method of claim 6 wherein the exposing step further comprises a step of:
supplying between 2 to 100 sccm of O₂;
supplying between 0 to 20 sccm of N₂, and
maintaining in the etch reactor a gas pressure between 2 and 100 mTorr.

8. A method for etching comprising an etch step and a residue removal step that are performed in the same reactor to etch a workpiece comprising a dielectric material having a dielectric constant that is greater than 4, comprising:
during the etch step, supplying 20 to 300 sccm of Cl₂ and 2 to 200 sccm of CO, maintaining in the reactor a gas pressure between 2 and 100 mTorr, applying a bias power to a cathode electrode between 0 and 300 Watt, and applying power to an inductively coupled antenna between 200 and 2500 Watt;
during the residue removal step, supplying 20 to 100 sccm of O₂ and 0 to 20 sccm of N₂, maintaining in the reactor a gas pressure between 2 to 100 mTorr, applying a bias power to a cathode electrode between 0 and 10 W, and applying power to an inductively coupled antenna between 200 and 2500 W; and
maintaining the workpiece at a temperature between 0 and 500 degrees Celsius.

9. A computer-readable medium containing software that when executed by a computer causes an etch reactor to plasma etch a dielectric material having a dielectric constant that is greater than 4 using a method comprising:
etching the dielectric material in a first plasma comprising a halogen containing gas and a reducing gas where said etching step produces a residue; and
cleaning the substrate using a second plasma comprising a residue cleaning gas to remove the residue from the substrate.

10. The computer-readable medium of claim 9 wherein said dielectric material is at least one of HfO₂, ZrO₂, Al₂O₃, BST, PZT, ZrSiO₂, HfSiO₂, HfSiON, and TaO₂.

11. The computer-readable medium of claim 9 wherein said dielectric material is HfO₂.

12. The computer-readable medium of claim 9 wherein the etching step and the cleaning step are performed sequentially in the same etch reactor.

13. The computer-readable medium of claim 9 wherein the halogen containing gas comprises a chlorine containing gas, the reducing gas comprises a carbon monoxide containing gas, and the residue cleaning gas comprises oxygen.

14. The computer-readable medium of claim 13 wherein the chlorine containing gas is Cl₂, the reducing gas is CO, and the residue cleaning gas is O₂ or a mixture of O₂ with N₂ or a mixture of O₂ with N₂ and an inert gas such as He.

15. The computer-readable medium of claim 14 wherein the exposing step further comprises a step of:
supplying between 20 to 100 sccm of O₂,
supplying between 0 to 20 sccm of N₂, and
maintaining in the etch reactor a gas pressure between 2 and 100 mTorr.
